(19) United States
(12) Patent Application Publication
(10) Pub. No.: US 2021/0258809 A1
(43) Pub. Date: Aug. 19, 2021

(54) CSI MEASUREMENT FOR MULTIPLE TRP/PANEL TRANSMISSION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 17/251,394

(22) PCT Filed: Jun. 19, 2018
(86) PCT No.: PCT/CN2018/091878

§ 371 Date: Dec. 11, 2020

(51) Int. Cl. H04W 24/08

(52) U.S. Cl. CPC H04W 24/08; H04W 24/10

(57) ABSTRACT

Embodiments of the present disclosure relate to a method, device and apparatus for Channel State Information (CSI) measurement and a method, device and apparatus for transmitting a CSI reference signal. In an embodiment of the present disclosure, a CSI-RS resource configuration is received from a network device, the CSI-RS resource configuration indicating a CSI-RS resource set including a plurality of CSI-RS resources. CSI measurement is then performed using one of a plurality of CSI-RS resource combinations, wherein the plurality of CSI-RS resource combinations being determined from the CSI-RS resource set based on a predefined combination rule. With embodiments of the present disclosure, it is possible to support CSI measurement for a multiple TPR/multiple panel transmission.

### FIELD OF THE INVENTION

The non-limiting and exemplary embodiments of the present disclosure generally relate to the field of wireless communication techniques, and more particularly relate to a method, device and apparatus for channel state information (CSI) measurement and a method, device and apparatus for transmitting a CSI reference signal (CSI-RS).

### BACKGROUND OF THE INVENTION

New radio access system, which is also called as NR system or NR network, is the next generation communication system. In Radio Access Network (RAN) #71 meeting for the third generation Partnership Project (3GPP) working group, study of the NR system was approved. The NR system will consider frequency ranging up to 100 Ghz with an object of a single technical framework addressing all usage scenarios, requirements and deployment scenarios defined in Technical Report TR 38.913, which includes requirements such as enhanced mobile broadband, massive machine-type communications, and ultra-reliable and low latency communications.

A discussion on multi-antenna technologies for the NR was started since May 2016 and it involves several aspects including multi-antenna scheme, beam management, Channel State Information (CSI) acquisition, and reference signal and quasi-co-located (QCL). Both single TRP transmission and multiple TRP transmission were agreed in the NR system.

Regarding the codeword (CW) to layer mapping in NR, it was already agreed that:
NR supports the following number of CWs per Physical Downlink Shared Channel (PDSCH)/Physical Uplink Shared Channel (PUSCH) assignment per UE:
   For 1 to 4-layer transmission: 1 CW
   For 5 to 8-layer transmission: 2 CWs
Confirm the following working assumption as an agreement:
   For 3 and 4-layer transmission, NR supports 1 CW per PDSCH/PUSCH assignment per UE
      For Further Study (FFS): the support of mapping 2-CW to 3 layers and 2-CW to 4 layers
DMRS port groups belonging to one CW can have different QCL assumptions
One Uplink (UL) - or Downlink (DL)-related Downlink Control Indication (DCI) includes one Modulation and Coding Scheme (MCS) per CW
One Channel Quality Indication (CQI) is calculated per CW.

With regard to CSI resource in the NR, it was also agreed that:
CSI-RS resource with 1-port and 2-port for one OFDM symbol can be used for beam management
A UE may assume that all CSI-RS ports within one CSI-RS resource are quasi co-located with respect to ‘QCL type A’ and ‘QCL type D’ when applicable.

Regarding single and multiple PDSCH from separate TRPs, it was further agreed that
Adopt the following for NR reception:
   A single NR-PDCCH schedules a single NR-PDSCH where separate layers are transmitted from separate TRPs
   Multiple NR-PDCCHs each scheduling a respective NR-PDSCH where each NR-PDSCH is transmitted from a separate TRP
   Note: the case of single NR-PDCCH scheduling single NR-PDSCH where each layer is transmitted from all TRPs jointly can be done in a spec-transparent manner
   Note: CSI feedback details for the above case can be discussed separately

The multiple TRP/panel transmission was down-prioritized and thus not discussed in details in Rel. 15. Thus, the current NR, CSI-RS configuration and transmission configuration indication (TCI) state configuration are based on single TRP/panel. For the multiple TRP transmission, TRPs are not QCLed and thus solutions of the CSI measurement and reporting for the single TRP transmission cannot be applied to the multiple TRP/panel transmission.

### SUMMARY OF THE INVENTION

To this end, in the present disclosure, there is provided a new solution of CSI measurement in a wireless communication system, to mitigate or at least alleviate at least part of the issues in the prior art.

According to a first aspect of the present disclosure, there is provided a method for CSI measurement in a wireless communication system. The method may include, receiving a CSI reference signal (CSI-RS) resource configuration from a network device, the CSI-RS resource configuration indicating a CSI-RS resource set including a plurality of CSI-RS resources; and performing CSI measurement using one of a plurality of CSI-RS resource combinations, the plurality of CSI-RS resource combinations being determined from the CSI-RS resource set based on a predefined combination rule.

According to a second aspect of the present disclosure, there is provided a method for transmitting CSI-RS in wireless communication system. The method may include transmitting a CSI-RS resource configuration to a terminal device, the CSI-RS resource configuration indicating a CSI-RS resource set including a plurality of CSI-RS resources; and transmitting a CSI-RS using one of a plurality of CSI-RS resource combinations, the plurality of CSI-RS resource combinations being determined from the CSI-RS resource set based on a predefined combination rule.

According to a third aspect of the present disclosure, there is provided a terminal device, wherein the terminal device is configured for CSI measurement. The terminal device may include a transceiver, and a processor, configured to perform or control the transceiver to, receive a CSI-RS resource configuration from a network device, the CSI-RS resource configuration indicating a CSI-RS resource set including a plurality of CSI-RS resources; and perform CSI measurement using one of a plurality of CSI-RS resource combinations, the plurality of CSI-RS resource combinations being determined from the CSI-RS resource set based on a predefined combination rule.

According to a fourth aspect of the present disclosure, there is provided a network device, wherein the network device is configured for transmitting CSI-RS. The network device may include a transceiver; and a processor, configured to perform or control the transceiver to: transmit a CSI-RS resource configuration to a terminal device, the CSI-RS resource configuration indicating a CSI-RS resource set including a plurality of CSI-RS resources; and transmit a CSI-RS using one of a plurality of CSI-RS resource combinations, the plurality of CSI-RS resource combinations being determined from the CSI-RS resource set based on a predefined combination rule.

According to a fifth aspect of the present disclosure, there is provided a terminal device. The terminal device may comprise a processor and a memory. The memory may be coupled with the processor and having program codes therein, which, when executed on the processor, cause the terminal device to perform operations of the method according to any embodiment according to the first aspect.

According to a sixth aspect of the present disclosure, there is provided a network device. The network device may comprise a processor and a memory. The memory may be coupled with the processor and have program codes therein, which, when executed on the processor, cause the network device to perform operations of the method according to any embodiment according to the second aspect.

According to a seventh aspect of the present disclosure, there is provided a computer-readable storage media with computer program codes embodied thereon, the computer program codes configured to, when executed, cause an apparatus to perform actions of the method according to any embodiment in the first aspect.

According to an eighth aspect of the present disclosure, there is provided a computer-readable storage media with computer program codes embodied thereon, the computer program codes configured to, when executed, cause an apparatus to perform actions of the method according to any embodiment in the second aspect.

According to a ninth aspect of the present disclosure, there is provided a computer program product comprising a computer-readable storage media according to the seventh aspect.

According to a tenth aspect of the present disclosure, there is provided a computer program product comprising a computer-readable storage media according to the eighth aspect.

With embodiments of the present disclosure, a new solution for CSI measurement is provided, which makes it possible to support CSI measurement for a multiple TRP/panel transmission.

### BRIEF DESCRIPTION OF THE DRAWINGS

The above and other features of the present disclosure will become more apparent through detailed explanation on the embodiments as illustrated in the embodiments with reference to the accompanying drawings, throughout which like reference numbers represent same or similar components and wherein:

FIG. 1 illustrates an example scenario of multiple TRP transmission in which the present disclosure can be implemented;

FIG. 2 illustrates a flow chart of a method for CSI measurement at a terminal device according to some embodiments of the present disclosure;

FIG. 3 illustrates TCI configurations for CSI-RS according to some embodiments of the present disclosure;

FIG. 4 illustrates a flow chart of a method for transmitting a CSI-RS for at a network device according to some embodiments of the present disclosure;

FIG. 5 schematically illustrates a block diagram of an apparatus for CSI measurement at a terminal device according to some embodiments of the present disclosure;

FIG. 6 schematically illustrates a block diagram of an apparatus for transmitting CSI-RS at a network device according to some embodiments of the present disclosure;

FIG. 7 illustrates a diagram of TCI configurations for PDSCH in a two-TRP transmission according to some embodiments of the present disclosure; and

FIG. 8 schematically illustrates a simplified block diagram of an apparatus 810 that may be embodied as or comprised in a terminal device like UE, and an apparatus 820 that may be embodied as or comprised in a network device like gNB as described herein.

### DETAILED DESCRIPTION OF EMBODIMENTS

Hereinafter, the solution as provided in the present disclosure will be described in details through embodiments with reference to the accompanying drawings. It should be appreciated that these embodiments are presented only to enable those skilled in the art to better understand and implement the present disclosure, not intended to limit the scope of the present disclosure in any manner.

In the accompanying drawings, various embodiments of the present disclosure are illustrated in block diagrams, flow charts and other diagrams. Each block in the flowcharts or blocks may represent a module, a program, or a part of code, which contains one or more executable instructions for performing specified logic functions, and in the present disclosure, a dispensable block is illustrated in a dotted line. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

Generally, all terms used in the claims are to be interpreted according to their ordinary meaning in the technical field, unless explicitly defined otherwise herein. All references to “a/an/the/said [element, device, component, means, step, etc.]” are to be interpreted openly as referring to at least one instance of said element, device, component, means, unit, step, etc., without excluding a plurality of such devices, components, means, units, steps, etc., unless explicitly stated otherwise. Besides, the indefinite article “a/an” as used herein does not exclude a plurality of such steps, units, modules, devices, and objects, and etc.

Additionally, in a context of the present disclosure, user equipment (UE) may refer to a terminal, a Mobile Terminal (MT), a subscriber station, a portable subscriber station, Mobile Station (MS), or an Access Terminal (AT), and some or all of the functions of the UE, the terminal, the MT, the SS, the portable subscriber station, the MS, or the AT may be included. Furthermore, in the context of the present disclosure, the term “BS” may represent, e.g., a node B (NodeB or NB), an evolved NodeB (eNodeB or eNB), gNB (next generation Node B), a radio header (RH), a remote radio head (RRH), a relay, or a low power node such as a femto, a pico, and so on.

As mentioned in hereinabove, in Rel. 15 of the NR system, CSI-RS configuration and TCI state configuration are based on single TRP/panel. While for the multiple TRP transmission, TRPs are not QCLed and thus solutions of the CSI measurement and reporting for the single TRP transmission cannot applied to the multiple TRP/panel transmission.

Embodiments of the present disclosure provide a solution for CSI measurement. The basic idea is to transmit, at a network device, CSI-RS resource configuration to indicate a CSI-RS resource set including a plurality of CSI-RS resources, and determine, by both the network device and the terminal device, a plurality of CSI-RS resource combinations from the CSI-RS resource set and select one combination for CSI measurement. By means of the CSI-RS resource set and the predefined combination rule, it may enable the CSI measurement for the multiple TPR/multiple panel transmission. In addition, in a different aspect, it is also proposed a solution of TCI configuration for PDSCH or PDCCH.

In some embodiments of the present disclosure, the terminal device receives, from a network device, a CSI-RS resource configuration indicating a CSI-RS resource set including a plurality of CSI-RS resources and performs the CSI measurement using one of a plurality of CSI-RS resource combinations determined from the CSI-RS resource set based on a predefined combination rule. The network device transmits to a terminal device a CSI-RS resource configuration indicating a CSI-RS resource set including a plurality of CSI-RS resources and transmits a CSI-RS using one of a plurality of CSI-RS resource combinations determined from the CSI-RS resource set based on a predefined combination rule.

Please be noted that basic idea and embodiments of the present disclosure can be used for the multiple TRP transmission. When they are used for the multiple panel transmission, CSI-RS transmission is performed through respective TRPs for the multiple TRP transmission and the CSI measurement will be respectively made for these TRPs. It is to be also understood that the basic idea and embodiments disclosed herein may also be used for the multiple panel transmission, wherein a panel denotes a group of antennas on the network device and/or user terminal device and the multiple panel transmission means transmission using multiple panels for single user device. When the basic idea and embodiments are used for the multiple panel transmission, the CSI-RS transmission is performed through respective panels for the multiple panel transmission and the CSI measurement will be respectively made for these panels instead of respective TRPs.

Hereinafter, reference will be made to FIGS. 1 to 8 to describe solutions as proposed in the present disclosure in details by taking the multiple TRP transmission as an example. However, it shall be appreciated that following embodiments are given only for illustrative purposes and the present disclosure is not limited thereto. Embodiments of the present disclosure can be used for the multiple panel transmission as well. And more especially, different embodiments as described herein can be implemented alone and separately or combined in any suitable manner as long as it is feasible from a point of the technical view.

FIG. 1 illustrates an example scenario of multiple TRP transmission in which the present disclosure can be implemented. In FIG. 1, a two-TRP transmission is illustrated in which a single UE 110 can be served by two TRPs. As illustrated, the UE 110 could receive signals such as CSI-RS from both TRP1 120 and TRP2 130 at the same time. Embodiments of the present disclosure are just directed to such an example scenario to provide a new solution for CSI measurement.

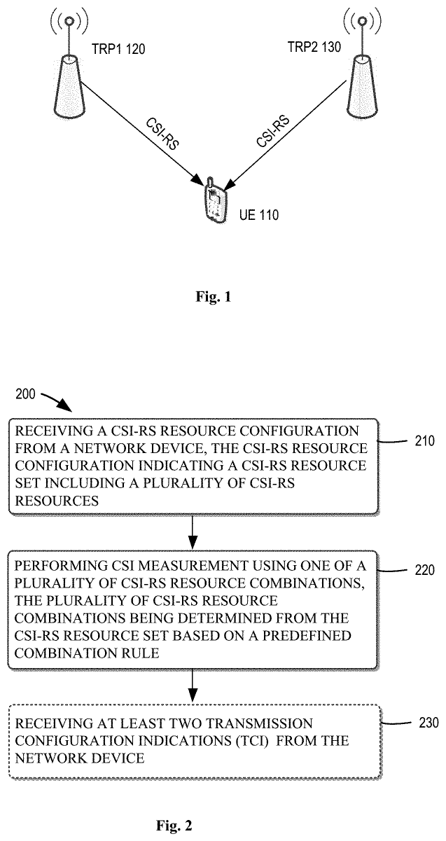

FIG. 2 schematically illustrates a flow chart of a method for CSI measurement at a terminal device according to some embodiments of the present disclosure. The method 200 may be performed at a terminal device, for example a terminal device like UE, or other like devices.

As illustrated in FIG. 2, in step 210, the terminal device receives a CSI-RS resource configuration from a network device, wherein the CSI-RS resource configuration indicates a CSI-RS resource set including a plurality of CSI-RS resources. In embodiments of the present disclosure, a CSI-RS resource configuration will be transmitted to the terminal device to indicate the CSI-RS resource set configured for the terminal device. The CSI-RS resource configuration can be transmitted to the terminal device in various way, like through RRC signaling, MAC CE, or physical layer signaling.

Next in step 220, the terminal device performs CSI measurement using one of a plurality of CSI-RS resource combinations, wherein the plurality of CSI-RS resource combinations are determined from the CSI-RS resource set based on a predefined combination rule. In embodiments of the present disclosure, the predetermined combination rule may be used to determine a plurality of CSI-RS resource combinations from the CSI-RS resource set indicated by the CSI-RS resource configuration. The predetermined combination rule can be known for both the network device and the terminal device and in such way, both of them could determine the same CSI-RS resource combinations from the same CSI-RS resource set. Then, one of the plurality of CSI-RS resource combinations can be selected from the plurality of CSI-RS resource combinations for CSI measurement, for example, based on the channel qualities of respective combinations.

In some embodiments of the present disclosure, each of the plurality of CSI-RS resource combinations contains a combination of ports from one CSI-RS resource in the CSI-RS resource set. In other word, according to the predetermined combination rule, one CSI-RS resource with N ports will be disaggregated into M subsets and each subset contain N/M ports and the combinations could be from by combining ports in these subsets. For example, for a two-TRP transmission, a CSI-RS resource set with two or four ports in one symbol can be configured for a terminal device for a purpose of beam management. In such a case, for a CSI-RS resource set with two ports, one port can be used for TRP1 and the other one can be used for TRP2. In addition, the two ports may not be Code Domain Multiplexing (CDM). As another example, for a CSI-RS resource set with four ports, two ports can be used for TRP1 and the other two can be used for TRP2. Then further based on the predetermined combination rule known for both the terminal device and network device, it could obtain the plurality of CSI-RS resource combinations for TRP1 and TRP2 from the aggregated subsets. In addition, different subsets may have different power ratios and in other words, at least two resources in a CSI-RS resource combination may have different power ratios.

In some embodiments of the present disclosure, each of the plurality of CSI-RS resource combinations contains a combination of CSI-RS resources from the CSI-RS resource set. In other word, according to the predetermined combination rule, one CSI-RS resource set with K CSI-RS resources can be divided or grouped into L subsets each containing K/L resources and the combinations could be from by combining resources in these subsets. For example, for a two-TRP transmission, the number K of CSI-RS resources {for example, R₁, R₂, . . . R_{K-1}, R_{K}} contained within a CSI-RS resource set is a multiple of 2. Thus, from the K/2 CSI resources, it may form a plurality of resource combination (pairs) based on the predetermined combination rule known for both the terminal device and the network device, and each pair contains two CSI-RS resources. For example, the CSI-RS resource pair may include CSI-RS resources with two consecutive indexes, {(R₁, R₂), (R₃, R₄), . . . , (R_{K-1}, R_{K})}. For another example, the K CSI-RS resources may be divided into two subsets, {R₁, R₂, . . . R_{K/2-1}, R_{K/2}} and {R_{K/2+1}, R_{K/2+2}, . . . R_{K-1}, R_{K}}, and the CSI-RS resource pair may include CSI-RS resources from two subsets, {(R₁, R_{K/2+1}), (R₂, R_{K/2+2}), . . . , (R_{K/2-1}, R_{K-1}), (R_{K/2}, R_{K})}. In addition, different subsets may have different power ratios and in other words, at least two resources in a CSI-RS resource combination may have different power ratios.

In some embodiments of the present disclosure, resources in a CSI-RS resource combination are located in the same slot or consecutive slots, or have an interval thereamong less than predetermined number of symbols, especially for beam management, CSI acquisition, bean sweeping, or beam tracking For example, for beam management in two-TRP transmission case, two CSI resources in a CSI-RS resource pair are frequency division multiplexed in one symbol and each CSI-RS resource may include one or two ports.

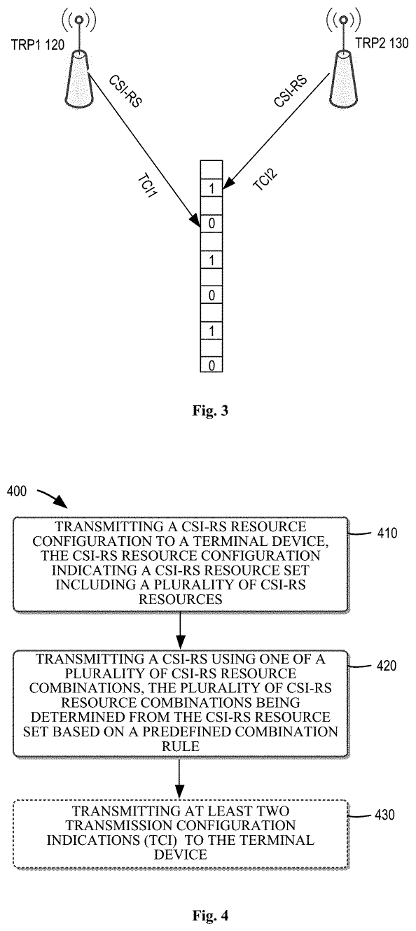

In some embodiments of the present disclosure, CSI-RS ports in a CSI-RS resource combination might be non-QCLed and thus, in step 330, the terminal device may further receive at least two transmission configuration indications (TCI) from the network device. As illustrated in FIG. 3, two TCIs respectively for at least two CSI-RS ports in the CSI resource combination can be transmitted from the network device to the terminal device. The at least two TCIs, particularly two TCI state identities (ID), are directed to at least two subsets disaggregated from one CSI-RS resource set. Thus, in performing CSI measurement, it may further use at least two quasi-co-location (QCL) configurations indicated by the at least two TCIs. In other words, the CSI measurement could be performed by using the one of a plurality of CSI-RS resource combinations with the at least two quasi-co-location (QCL) configurations indicated by the at least two TCIs.

FIG. 4 further illustrates a flow chart of a method for transmitting CSI-RS according to an embodiment of the present disclosure. The method 400 may be performed at a network device, for example a base station like gNB, or other like device.

As illustrated in FIG. 4, first in step 410, the network device may transmit a CSI-RS resource configuration to a terminal device, wherein the CSI-RS resource configuration indicates a CSI-RS resource set including a plurality of CSI-RS resources. In embodiments of the present disclosure, the CSI-RS resource set configured for the terminal device could be indicated by a CSI-RS resource configuration. The CSI-RS configuration can be transmitted to the terminal device in various way, like through RRC signaling, MAC CE, or physical layer signaling.

Then, in step 420, the network device transmits a CSI-RS using one of a plurality of CSI-RS resource combinations, wherein the plurality of CSI-RS resource combinations are determined from the CSI-RS resource set based on a predefined combination rule. In embodiments of the present disclosure, the predetermined combination rule may be used to determine a plurality of CSI-RS resource combinations from the CSI-RS resource set configured for terminal device. The predetermined combination rule can be known for both the network device and the terminal device and in such way, both of them could determine the same CSI-RS resource combinations from the same CSI-RS resource set. Then, one of the plurality of CSI-RS resource combinations can be selected from the plurality of CSI-RS resource combinations for CSI measurement, for example, based on the channel qualities of respective combinations.

In some embodiments of the present disclosure, each of the plurality of CSI-RS resource combinations contains a combination of ports from one CSI-RS resource in the CSI-RS resource set. In other word, according to the predetermined combination rule, one CSI-RS resource with N ports will be disaggregated into M subsets and each subset contain N/M ports and the combinations could be from by combining ports in these subsets.

In some embodiments of the present disclosure, each of the plurality of CSI-RS resource combinations contains a combination of CSI-RS resources from the CSI-RS resource set. In other word, according to the predetermined combination rule, one CSI-RS resource set with K CSI-RS resources can be divided or grouped into L subsets each containing K/L resources and the combinations could be from by combining resources in these subsets.

In some embodiments of the present disclosure, resources in a CSI-RS resource combination are located in the same slot. Alternatively, the resources in a CSI-RS resource combination are located in consecutive slots. Or alternatively, resources in the CSI-RS resource combination have an interval thereamong less than predetermined number of symbols.

In some embodiments of the present disclosure, at least two resources in a CSI-RS resource combination may have different power ratios.

In some embodiments of the present disclosure, in step 430, the terminal device may further transmit at least two transmission configuration indications (TCI) for at least two CSI-RS ports in the CSI resource combination to the terminal device. In such a case, a CSI-RS transmission may be performed with the at least two QCL configurations indicated by the at least two TCIs. In other words, a CSI-RS can be transmitted using one of a plurality of CSI-RS resource combinations, with the at least two QCL configurations indicated by the at least two TCIs.

In some embodiments of the present disclosure, the CSI reference signals may be transmitted through multiple transmission reception points (TRPs) for a multiple TRP transmission.

In some embodiments of the present disclosure, the CSI measurement reference signals may be transmitted through multiple panels for a multiple panel transmission.

Hereinabove, example methods of transmitting CSI-RS at the network side are described in brief hereinbefore with reference to FIG. 4. However, it can be understood that operations at the network device are substantially corresponding to those at the terminal device and thus for some details of operations, one may refer to description with reference to FIGS. 1 to 3.

FIG. 5 schematically illustrates a block diagram of an apparatus for CSI measurement at a terminal device according to some embodiments of the present disclosure. The apparatus 500 may be implemented at a terminal device, for example UE or other like terminal devices.

As illustrated in FIG. 500, the apparatus 500 may include a configuration reception module 510 and a CSI measurement report 520. The configuration reception module 510 is configured to receive a CSI-RS resource configuration from a network device, wherein the CSI-RS resource configuration indicates a CSI-RS resource set including a plurality of CSI-RS resources. The CSI measurement module 520 is configured to perform CSI measurement using one of a plurality of CSI-RS resource combinations, wherein the plurality of CSI-RS resource combinations can be determined from the CSI-RS resource set based on a predefined combination rule.

In some embodiments of the present disclosure, each of the plurality of CSI-RS resource combinations may contain a combination of ports from one CSI-RS resource in the CSI-RS resource set.

In some embodiments of the present disclosure, each of the plurality of CSI-RS resource combinations may contain a combination of CSI-RS resources from the CSI-RS resource set.

In some embodiments of the present disclosure, resources in a CSI-RS resource combination may be located in the same slot; or wherein the resources in a CSI-RS resource combination may be located in consecutive slots, or wherein resources in the CSI-RS resource combination may have an interval thereamong less than a predetermined number of symbols.

In some embodiments of the present disclosure, at least two resources in a CSI-RS resource combination may have different power ratios.

In some embodiments of the present disclosure, the apparatus 500 further comprise a TCI reception module 530 configured to receive at least two transmission configuration indications (TCI) from the network device. In such embodiments, the CSI measurement module may be further configured to perform the CSI measurement using the one of a plurality of CSI-RS resource combinations with the at least two quasi-co-location (QCL) configurations indicated by the at least two TCIs.

In some embodiments of the present disclosure, the CSI measurement may be performed for multiple transmission reception points (TRPs) for a multiple TRP transmission.

In some embodiments of the present disclosure, the CSI measurement may be performed for multiple panels for a multiple panel transmission.

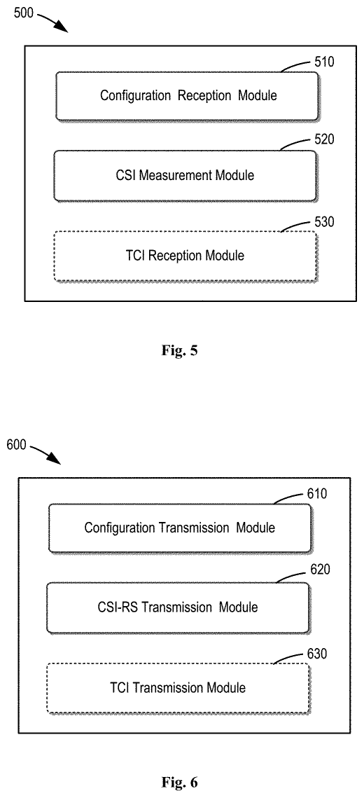

FIG. 6 schematically illustrates a block diagram of an apparatus for transmitting CSI-RS at a network device according to some embodiments of the present disclosure. The apparatus 600 could be implemented on the network device or node for example gNB, or other like network devices.

As illustrated in FIG. 6, apparatus 600 may include a configuration transmission module 610 and a CSI-RS transmission model 620. The configuration transmission module 610 can be configured to transmit a CSI reference signal (CSI-RS) resource configuration to a terminal device, wherein the CSI-RS resource configuration indicates a CSI-RS resource set including a plurality of CSI-RS resources. The CSI-RS transmission model 620 can be configured to transmit a CSI-RS using one of a plurality of CSI-RS resource combinations, wherein the plurality of CSI-RS resource combinations may be determined from the CSI-RS resource set based on a predefined combination rule.

In some embodiments of the present disclosure, each of the plurality of CSI-RS resource combinations may contain a combination of ports from one CSI-RS resource in the CSI-RS resource set.

In some embodiments of the present disclosure, each of the plurality of CSI-RS resource combinations may contain a combination of CSI-RS resources from the CSI-RS resource set.

In some embodiments of the present disclosure, resources in a CSI-RS resource combination may be located in the same slot. Alternatively, the resources in a CSI-RS resource combination are located in consecutive slots. Or alternatively, resources in the CSI-RS resource combination may have an interval thereamong less than a predetermined number of symbols.

In some embodiments of the present disclosure, at least two combinations in the plurality of CSI-RS resource combinations may have different power ratios.

In some embodiments of the present disclosure, the apparatus 600 may further comprise a TCI transmission module 630 configured to transmit at least two transmission configuration indications (TCI) to the terminal device. The CSI-RS transmission module may be further configured to transmit the CSI-RS using one of a plurality of CSI-RS resource combinations, with the at least two quasi-co-location (QCL) configurations indicated by the at least two TCIs.

In some embodiments of the present disclosure, the CSI reference signals may be transmitted through multiple transmission reception points (TRPs) for a multiple TRP transmission.

In some embodiments of the present disclosure, the CSI measurement reference signals may be transmitted through multiple panels for a multiple panel transmission.

Hereinbefore, apparatuses 500 and 600 are described with reference to FIGS. 5 and 6 in brief. It can be noted that the apparatuses 500 to 600 may be configured to implement functionalities as described with reference to FIGS. 1 to 4. Therefore, for details about the operations of modules in these apparatuses, one may refer to those descriptions made with respect to the respective steps of the methods with reference to FIGS. 1 to 4.

It is further noted that components of apparatuses 500 and 600 may be embodied in hardware, software, firmware, and/or any combination thereof. For example, the components of apparatuses 500 and 600 may be respectively implemented by a circuit, a processor or any other appropriate selection device.

In another aspect, there is further provided a solution for TCI configurations of multiple TRP/panel transmission, which can be implemented separately or in combination with the solution for CSI measurement as described hereinabove. In this aspect, the basic idea is to provide two TCI from the network device for the signal transmission such as PDSCH or PDCCH.

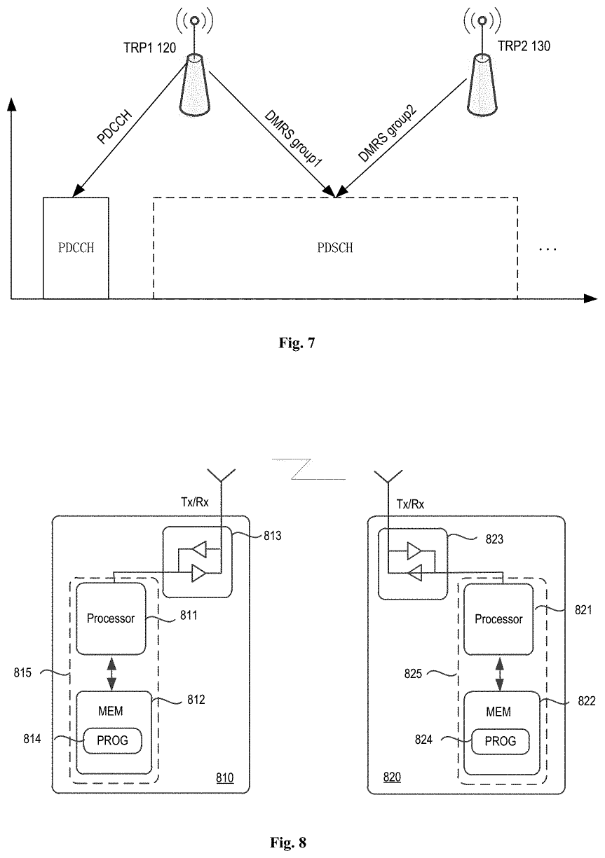

In some embodiments of the present disclosure, at least two transmission configuration indications (TCI) can be transmitted from the network device in a single physical downlink control channel (PDCCH) as illustrated in FIG. 7 and the PDSCH can be received based on the relationship between the scheduling offset between the PDCCH and the PDSCH and a threshold time required for beginning the transmission on a predetermined direction after the scheduling. Hereinafter, a two-TRP transmission will be taken as an example to describe this aspect of the present disclosure; however, it shall be noted that the embodiments of the present disclosure, could also be used for multiple panel transmission or a multiple TRP transmission involving more than two TRPs.

For a two-TRP transmission, if two TRPs are from different serving cells or different bandwidth parts (BWPs), one PDSCH can be configured with two TCI state IDs respectively for two different serving cells or BWPs. If the scheduling offset is not less than the threshold time, the terminal device may assume that antenna ports of each demodulation reference signal (DMRS) port group of PDSCH are quasi-QCLed with RS in the corresponding TCI state with regard to the QCL configurations indicated by the TCIs. Thus, in such a case, the network device may transmit the PDSCH using two QCL configurations indicated by the two TCIs and the terminal device may receive the PDSCH using two QCL configurations indicated by the two TCIs. On the other hand, if the scheduling offset is less than and/or equal to the threshold time, the network device and the terminal device may operate in different ways.

In some embodiments of the present disclosure, one or more CORESETs within the active BWP of one of the serving cells are configured for the UE and the index of the serving cell in the configured TCI state is same with that in the previous PDCCH (like the latest one). In such a case, the network device may use a default QCL configuration for the serving cell and the terminal device may use the default QCL configuration for the serving cell and discard signals from the TRPs in other serving cell. For example, the terminal device may assume that antenna ports of DMRS port group of PDSCH are quasi-QCLed with RS in the TCI state with regard to the QCL configurations used for the lowest CORREST-ID in the latest slot (in which one or more CORESETs within the active BWP of the serving cell are configured for the UE) and consider the lowest CORREST-ID in the latest slot as the default QCL configuration.

In some embodiments of the present disclosure, one or more CORESETs within the active BWP of each of the serving cells are configured for the UE and in such a case, the network device and the terminal device may use two default QCL configurations respectively for the two serving cell. For example, the terminal device may consider two lowest CORREST-IDs in the latest slots as the default QCL configurations for respective serving cells.

In some embodiments of the present disclosure, if the scheduling offset is less than and/or equal to the threshold, the network device and terminal device may assume that two DMRS groups are QCLed and with same TCI state as lowest CORESET ID, regardless two DMRS groups configured with the same TCI state or different TCI states. In other words, the network device and the terminal device will consider the lowest CORREST-ID in the latest slot as the default QCL configuration, stop the multiple TRP transmission and switch back to a single TRP transmission.

In some embodiments of the present disclosure, for cross-carrier or cross TRP scheduling, if the scheduling offset is less than and/or equal to the threshold, the CIF filed can be ignored and the PDSCH can be transmitted in the self-carrier or self-TRP and the lowest COREST ID in the latest slot can be sued as the default QCL configuration. In other words, the network device and the terminal device will stop the cross-carrier or cross TRP scheduling and switch back to scheduling in self-carrier or self-TRP.

In some embodiments of the present disclosure, for multiple panel transmission, at least two transmission configuration indications (TCI) for PDCCH reception can be transmitted from the network device in a single MAC CE and the PDCCH reception can be performed based on the scheduling offset between the MAC CE transmission and the PDCCH and a threshold time required for beginning the transmission on a predetermined direction.

For example, UE may have N panels and PDCCH can be received based on M panels among N panels (1<=M<N). A two-panel transmission is taken as an example, there might be two QLC types of D for one UE and other QCL types may be same for the two panels. Two TCIs can be selected for PDCCH for two panels and transmitted to the terminal device through MAC CE.

For various cases that the scheduling offset is not less than the threshold time, and the scheduling offset is not less than the threshold time, the default QCL configurations can be determined based on same manner as described with respect to transmission configuration indications for PDSCH.

In some embodiments of the present disclosure, the scheduling offset is not less than the threshold time, and in such a case, the terminal device may receive PDCCH from different panels using QCL configurations indicated by the at least two TCIs.

In some embodiments of the present disclosure, the scheduling offset is less than and/or equal to the threshold time, and in such a case, the terminal device may receive PDCCH using a default QCL configuration of a previous PDCCH for a corresponding panel and drop the signals from the other panels.

In some embodiments of the present disclosure, the scheduling offset is less than the threshold time, and in such a case, the terminal device may receive PDCCH using at least two default QCL configurations of previous PDCCHs for respective panels.

In some embodiments of the present disclosure, the scheduling offset is less than and/or equal to the threshold time, and in such a case, the terminal device may receive PDCCH using a default QCL configuration of a previous PDCCH for a corresponding panel and stop the multiple panel transmission.

In addition, it is to be understood that at the network device, corresponding operations will also be performed to implement the TCI configuration and for details, one may refer to the description with reference to the operations at the terminal device.

FIG. 8 schematically illustrates a simplified block diagram of an apparatus 810 that may be embodied as or comprised in a terminal device like UE, and an apparatus 820 that may be embodied as or comprised in a network device like gNB as described herein.

The apparatus 810 comprises at least one processor 811, such as a data processor (DP) and at least one memory (MEM) 812 coupled to the processor 811. The apparatus 810 may further include a transmitter TX and receiver RX 813 coupled to the processor 811, which may be operable to communicatively connect to the apparatus 820. The MEM 812 stores a program (PROG) 814. The PROG 814 may include instructions that, when executed on the associated processor 811, enable the apparatus 810 to operate in accordance with embodiments of the present disclosure, for example method 200. A combination of the at least one processor 811 and the at least one MEM 812 may form processing means 815 adapted to implement various embodiments of the present disclosure.

The apparatus 820 comprises at least one processor 811, such as a DP, and at least one MEM 822 coupled to the processor 811. The apparatus 820 may further include a suitable TX/RX 823 coupled to the processor 821, which may be operable for wireless communication with the apparatus 810. The MEM 822 stores a PROG 824. The PROG 824 may include instructions that, when executed on the associated processor 821, enable the apparatus 820 to operate in accordance with the embodiments of the present disclosure, for example to perform method 400. A combination of the at least one processor 821 and the at least one MEM 822 may form processing means 825 adapted to implement various embodiments of the present disclosure.

Various embodiments of the present disclosure may be implemented by computer program executable by one or more of the processors 811, 821, software, firmware, hardware or in a combination thereof.

The MEMs 812 and 822 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 811 and 821 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method for channel state information (CSI) measurement in a wireless communication system, comprising:
receiving a CSI reference signal (CSI-RS) resource configuration from a network device, the CSI-RS resource configuration indicating a CSI-RS resource set including a plurality of CSI-RS resources; and
performing CSI measurement using one of a plurality of CSI-RS resource combinations, the plurality of CSI-RS resource combinations being determined from the CSI-RS resource set based on a predefined combination rule.

2. The method of claim 1, wherein each of the plurality of CSI-RS resource combinations contains a combination of ports from one CSI-RS resource in the CSI-RS resource set.

3. The method of claim 1, wherein each of the plurality of CSI-RS resource combinations contains a combination of CSI-RS resources from the CSI-RS resource set.

4. The method of claim 3, wherein resources in a CSI-RS resource combination are located in the same slot; or
wherein the resources in a CSI-RS resource combination are located in consecutive slots, or
wherein the resources in the CSI-RS resource combination have an interval thereamong less than a predetermined number of symbols.

5. The method of claim 1, wherein at least two resources in a CSI-RS resource combination have different power ratios.

6. The method of claim 1, further comprising:
receiving at least two transmission configuration indications (TCI) from the network device;
wherein the performing CSI measurement further comprises performing the CSI measurement using the one of a plurality of CSI-RS resource combinations with the at least two quasi-co-location (QCL) configurations indicated by the at least two TCIs.

7. The method of claim 1, wherein the CSI measurement is performed for multiple transmission reception points (TRPs) for a multiple TRP transmission.

8. The method of claim 1, wherein the CSI measurement is performed for multiple panels for a multiple panel transmission.

9. A method for transmitting channel state information reference signals (CSR-RS) in a wireless communication, comprising:
transmitting a CSI-RS resource configuration to a terminal device, the CSI-RS resource configuration indicating a CSI-RS resource set including a plurality of CSI-RS resources; and
transmitting a CSI-RS using one of a plurality of CSI-RS resource combinations, the plurality of CSI-RS resource combinations being determined from the CSI-RS resource set based on a predefined combination rule.

10. The method of claim 9, wherein each of the plurality of CSI-RS resource combinations contains a combination of ports from one CSI-RS resource in the CSI-RS resource set.

11. The method of claim 9, wherein each of the plurality of CSI-RS resource combinations contains a combination of CSI-RS resources from the CSI-RS resource set.

12. The method of claim 11, wherein resources in a CSI-RS resource combination are located in the same slot; or
wherein the resources in a CSI-RS resource combination are located in consecutive slots, or
wherein the resources in the CSI-RS resource combination have an interval thereamong less than a predetermined number of symbols.

13. The method of claim 9, wherein at least two resources in a CSI-RS resource combination have different power ratios.

14. The method of claim 9, further comprising:
transmitting at least two transmission configuration indications (TCI) to the terminal device; and
wherein transmitting the CSI-RS further comprises transmitting the CSI-RS using the one of a plurality of CSI-RS resource combinations with the at least two quasi-co-location (QCL) configurations indicated by the at least two TCIs.

15. The method of claim 9, wherein the CSI reference signals are transmitted through multiple transmission reception points (TRPs) for a multiple TRP transmission.

16. The method of claim 9, wherein the CSI measurement reference signals are transmitted through multiple panels for a multiple panel transmission.

17. A terminal device, comprising:
a transceiver, and
a processor, configured to perform or control the transceiver to perform the method of claim 1.

18. (canceled)

19. (canceled)

20. (canceled)
